(19) United States
(12) Patent Application Publication
(10) Pub. No.: US 2014/0097036 A1
(43) Pub. Date: Apr. 10, 2014

(54) MULTI-LAYER MATERIAL FOR APPLICATION TO A VEHICLE UNDERBODY

(71) Applicant: U.S. FARATHANE CORPORATION, Auburn Hills, MI (US)

(72) Inventors: Eric Lynn Camp, Rochester, MI (US); Jason Michael Randall, Bloomfield Hills, MI (US); Jim Louis Curtis, Oxford, MI (US)

(73) Assignee: U.S. Farathane Corporation, Auburn Hills, MI (US)

(21) Appl. No.: 13/840,001

(22) Filed: Mar. 15, 2013

Related U.S. Application Data
(60) Provisional application No. 61/709,618, filed on Oct. 4, 2012.

(51) Int. Cl. B60R 13/08

(52) U.S. Cl. CPC B60R 13/0861
USPC 181/290; 156/60; 156/196

(57) ABSTRACT

A dual layer material adapted to being applied to a vehicle underbody including a panel shaped body formed by a moldable polyethylene terephthalate (PET) layer joined with a polypropylene and glass composite layer in order to provide at least one of improved wear and abrasion resistance on an outer facing surface and acoustic noise attenuation on an inner vehicle facing surface. The dual layer material can also incorporate a bonding agent for adhering the layers together.

### CROSS-REFERENCE TO RELATED APPLICATIONS

This Application claims the benefit of U.S. Provisional Application 61/709,618 filed on Oct. 4, 2012, the contents of which are incorporated herein by reference in its entirety.

### FIELD OF THE INVENTION

The present application discloses a multi (such as dual) layer material, such as in one example including a moldable polyethylene terephthalate (PET) joined with a polypropylene (PP) and glass composite. The dual layer material is molded in a panel shape, such as utilizing any type of bonding agent and/or joining process, and is adapted for installation to a vehicle exterior underbody and in order to provide improved wear and abrasion resistance on the outer (PET) surface in combination with maintaining acoustic/noise dampening properties associated with the inner PP/Glass surface.

### BACKGROUND OF THE INVENTION

Sound and vibration dampening technology, such as incorporated into a vehicle panel construction is known in the art. A first example of this is depicted in French publication 2860468 which teaches a deflector 1 exhibiting a rigid panel 2 (understood to be a floor pan) including inner positioned and deformable components 3 disposed on an internal side of the panel. The deflector is further arranged so as to permit the components to be compressed once the deflector is mounted beneath a wall (interpreted as being the underside of the vehicle).

EP 2 251 231 teaches a multi-layer sound proofing panel including multiple layers of thermoplastic fiber, acoustic absorbers (23) made of foamed plastic (34), a staple fiber web (44), additional acoustic absorber (33) and interposed noise damping layers (27). EP 0 141 440 teaches a further related version of a double walled molding for reduction of sound in vehicles and engines by means of a single compression mold operation two packages, each consisting of a layer of pre polymer fibers and a foil of thermoplastics material. The compression mold is heated to a temperature which is sufficient to cause complete melting of the foil and complete polymerization of the pre polymer fibers.

Additional examples of vibration reduction and acoustical dampening structures are shown in each of WO 2006/105933, Schaube 2012/0034833, and Caprioli 2007/0208443.

### SUMMARY OF THE INVENTION

The present invention teaches a multi-layer material adapted to being applied to a vehicle underbody. The dual layer includes a panel shaped body formed by a moldable polyethylene terephthalate (PET) layer joined with a polypropylene and glass composite layer in order to provide at least one of improved wear and abrasion resistance on an outer facing surface and acoustic noise attenuation on an inner vehicle facing surface.

The dual layer material can also incorporate a bonding agent for adhering the layers together. The dual layer arrangement can also be configured as a plurality of individual panels assembled in edge-to-edge aligning fashion in order to most conveniently confirm to the underside architecture of the vehicle underbody.

A mold process is employed for conforming at least one of the layers from a flat sheet stock, with the first and second layers capable of being independently moldable in combination to confirm to the vehicle underbody. It is also envisioned that the layers can be adhered together either prior or subsequent to introduction within the mold process.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a side view in cross section of a composite of moldable PET plus PP/Glass panel according to one embodiment of the present invention;

FIG. 2 is a first rotated perspective of the composite panel and exhibiting an exterior/road surface facing PET material;

FIG. 3 is a second rotated perspective exhibiting the PP/Glass vehicle facing surface; and

FIG. 4 is a sample depiction of such a dual layer material exhibiting varying grades and types of both polypropylene and polyethylene terephthalate materials within the scope of the present invention;

### DETAILED DESCRIPTION OF THE PREFERRED EMBODIMENTS

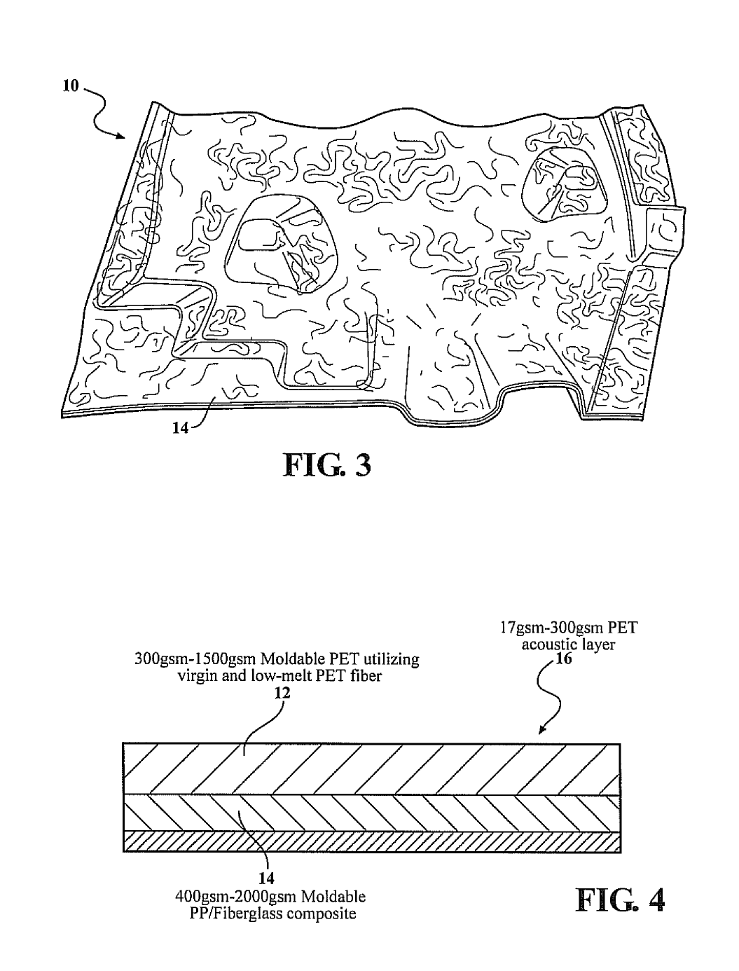

As previously described, the present application discloses a dual layer material which is adapted for such as vehicular applications, such as in one example including a moldable polyethylene terephthalate (PET) layer 12 joined with a polypropylene (PP) and glass composite 14 layer. As is further clearly depicted at 10 in each of FIGS. 2 and 3, the dual layer material is molded in a panel shape, such as utilizing any type of bonding agent and/or joining process, and is adapted for installation as one or more panels affixed to a vehicle exterior underbody, this again in order to provide improved wear and abrasion resistance on the outer (PET) surface in combination with maintaining acoustic (including each or all of noise dampening/absorptive/attenuation) properties associated with the inner PP/Glass surface.

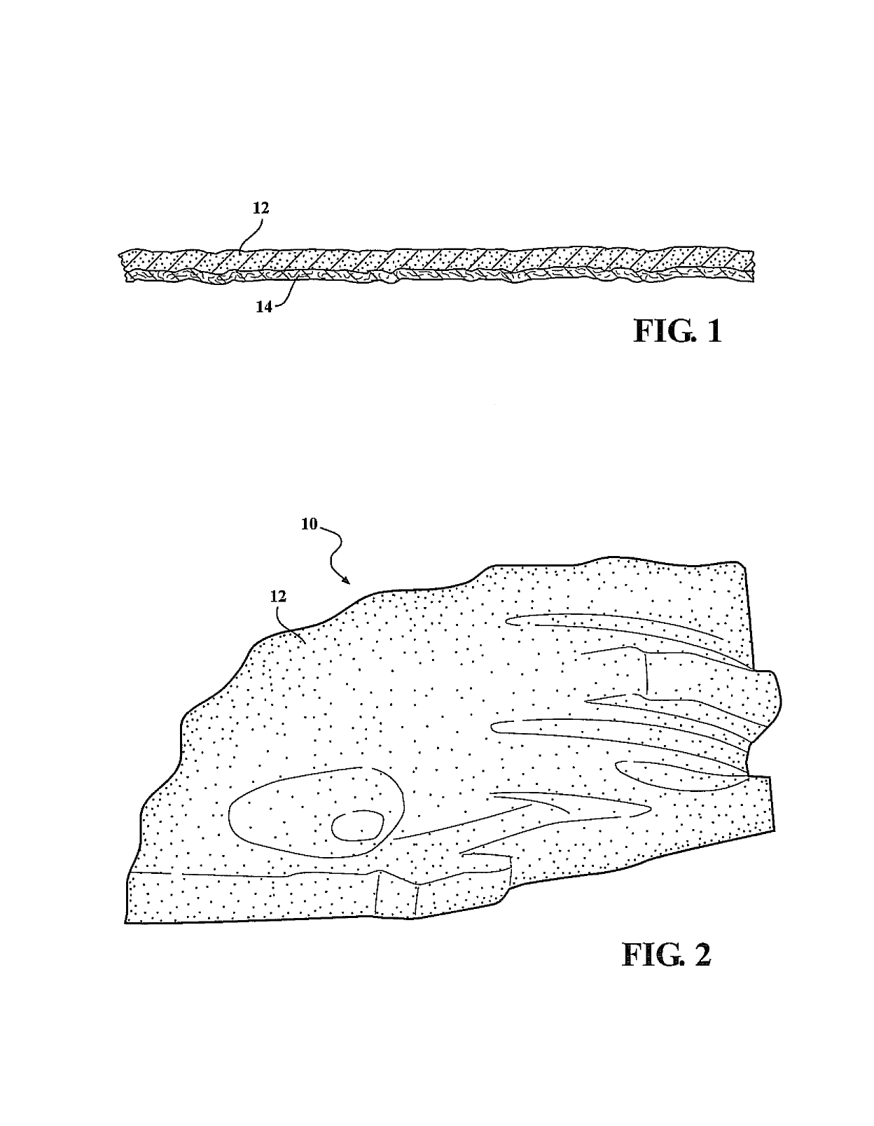

FIG. 1 is a side view in cross section of the composite of moldable PET plus PP/Glass panel according to one embodiment of the present invention. As previously described, the proposed composite provides a variety of desired factors in the use of two independently moldable composites which, in combination, address a number of pre-existing durability and acoustic issues relating to automotive underbodies.

An associated process is also contemplated for producing the dual layer panel construction in an over/under fashion as depicted. This can include the individual moldable PET 12 and PP/Glass 14 layers being individually preformed into the desired end shape, following which they are adhered together through the use of a chemical adhesive or other bonding agent.

Alternatively, the layers 12 and 14 can be provided in sheet stock form and, upon being sandwiched, are inserted into a mold and formed with a combination of heat and compression (with or without the bonding agent) in order to form the desired shape. A variation of this process could further contemplate the PP/Glass layer 14 being pre-formed in the end-desired configuration, with the PET material 12 being initially flat stock material and which is conformed against the PP/Glass layer 14 (such as within a cavity mold) to achieve the desired shape.

As further best shown in FIGS. 2 and 3, the composite panel construction of the dual layer shield is configured such that it conforms to a vehicle underbody architecture of a given make and model of vehicle. This can again include the shield being produced as a single large panel or, alternatively, by reconfiguring as a larger number of individual panels which are individually formed in a desired three dimensional configuration (as again best depicted in FIG. 3) and subsequently assembled in edge-to-edge aligning fashion in order to most conveniently confirm to the underside architecture of the vehicle underbody. To this end, the present invention contemplates the use of any suitable configured mold or molding technology as is known in the art for forming a single or multiple number of panels into a desired three dimensional shield or suitable underbody configuration.

Referring further to FIG. 4, a sample depiction is provided of such a dual layer material exhibiting varying grades and types of both polypropylene and polyethylene terephthalate materials within the scope of the present invention. In selected and non-limiting examples, this can include the PET layer 12 integrating a moldable PET in a range of 300 gsm-1500 gsm utilizing virgin and low-melt PET fiber. A separate and additional acoustic dampening layer 16 incorporating a PET material in a range of 17-300 gsm can be provided such as without limitation applied over the PP (polypropylene) layer 14 facing the vehicle interior. Alternatively, it is also envisioned that the dampening layer 16 can be intermixed with the other PET layer 12 or applied on a reverse (outer facing) surface of the material.

Also depicted again at 14 is a layer of a molded polypropylene/fiberglass composite (vehicle interior facing side) and which can include a range of 400-2000 gsm. For purposes of the above explanation, the standard measurement for weight and quality of fabrics is grams per square meter, usually abbreviated as GSM. This is the accepted standard in the United States as well as in foreign countries. Towels and bath robes typically vary from 300 to 800 GSM; other fabrics may have values as low as 100 GSM. The same units are used for toilet paper and other tissues (18 to 22 GSM is typical) as well as paper towels (35 to 50 GSM is typical).

A corresponding mold process is provided for creating a multi-layer material and includes the steps of forming a first moldable polyethylene terephthalate (PET) layer and joining a second polypropylene and glass composite layer to the first PET layer in order to provide at least one of improved wear and abrasion resistance on an outer facing surface and acoustic noise attenuation on an inner vehicle facing surface. Additional steps include adding a bonding agent for adhering the layers together.

Other steps include molding the first and second layers into a three dimensional configuration to conform to a vehicle underbody application. The layers can be adhered together either prior or subsequent to forming. A second polyethylene terephthalate layer can be applied to an exterior facing surface of the polypropylene and glass composite layer opposite the first moldable polyethylene terephthalate layer.

Having described our invention, other and additional preferred embodiments will become apparent to those skilled in the art to which it pertains, and without deviating from the scope of the appended claims.

We claim:

1. A material construction adapted to being applied to a vehicle underbody, comprising a panel shaped body formed by a moldable polyethylene terephthalate (PET) layer joined with a polypropylene and glass composite layer in order to provide at least one of improved wear and abrasion resistance on an outer facing surface and acoustic noise attenuation on an inner vehicle facing surface.

2. The material as described in claim 1, further comprising a bonding agent for adhering said layers together.

3. The material as described in claim 2, further comprising a plurality of individual and three dimensional configured panels which are assembled in edge-to-edge aligning fashion in order to most conveniently confirm to the underside architecture of the vehicle underbody.

4. A mold process for creating a multi-layer material, comprising the steps of:
forming a first moldable polyethylene terephthalate (PET) layer; and
joining a second polypropylene and glass composite layer to said first PET layer in order to provide at least one of improved wear and abrasion resistance on an outer facing surface and acoustic noise attenuation on an inner vehicle facing surface.

5. The mold process as described in claim 4, further comprising the step of adding a bonding agent for adhering said layers together.

6. The mold process as described in claim 4, further comprising the step of molding said first and second layers into a three dimensional configuration to conform to a vehicle underbody application.

7. The mold process as described in claim 5, further comprising the step of said layers being adhered together either prior or subsequent to forming.

8. The mold process as described in claim 4, further comprising forming a second polyethylene terephthalate layer applied to an exterior facing surface of said polypropylene and glass composite layer opposite said first moldable polyethylene terephthalate layer.

9. A material construction adapted to being applied to a vehicle underbody, comprising a panel shaped body formed by a moldable polyethylene terephthalate (PET) layer joined with a polypropylene and glass composite layer by a bonding agent for adhering said layers together in order to provide at least one of improved wear and abrasion resistance on an outer facing surface and acoustic noise attenuation on an inner vehicle facing surface.

10. The material as described in claim 9, further comprising a plurality of individual and three dimensional configured panels which are assembled in edge-to-edge aligning fashion in order to most conveniently confirm to the underside architecture of the vehicle underbody.

11. The material as described in claim 9, further comprising a second polyethylene terephthalate layer applied to an exterior facing surface of said polypropylene and glass composite layer opposite said first moldable polyethylene terephthalate layer.

12. The material as described in claim 9, said moldable polyethylene terephthalate (PET) layer having a rating in a range of 300-1500 gsm.

13. The material as described in claim 9, said polypropylene and glass composite layer having a rating in a range of 400-2000 gsm.

14. The material as described in claim 11, said second polyethylene terephthalate layer having a rating in a range of 17-300 gsm.
